(19) United States
(12) Patent Application Publication
(10) Pub. No.: US 2012/0027235 A1
(43) Pub. Date: Feb. 2, 2012

(54) MEMS CAPACITIVE MICROPHONE

(76) Inventors: Chun-Kai CHAN, Hsinchu City (TW); Weileun Fang, Hsinchu City (TW)

(21) Appl. No.: 12/844,378

(22) Filed: Jul. 27, 2010

(51) Int. Cl. H04R 25/00

(52) U.S. Cl. 381/174

(57) ABSTRACT

The present invention discloses an MEMS capacitive microphone, which comprises a supporting portion and a diaphragm, wherein the supporting portion supports the central portion of the diaphragm to facilitate releasing the residual stress of the diaphragm generated in the thermal fabrication process. Thereby is maintained the flatness of the diaphragm and promoted the precision of sensing capacitance.

### FIELD OF THE INVENTION

The present invention relates to an MEMS capacitive microphone, particularly to an MEMS capacitive microphone whose diaphragm has high flatness and low residual stress.

### BACKGROUND OF THE INVENTION

The current tendency is toward fabricating slim, compact, lightweight and high-performance electronic products, including microphones. A microphone is used to receive sound and convert acoustic signals into electric signals. Microphones are extensively used in daily-life appliances, such as telephones, mobiles phones, recording pens, etc. For a capacitive microphone, variation of sound forces the diaphragm to deform correspondingly in a type of acoustic waves. The deformation of the diaphragm induces capacitance variation. The variation of sounds can thus be obtained via detecting the voltage difference caused by capacitance variation.

Distinct from the conventional electret condenser microphones (ECM), mechanical and electronic elements of MEMS (Micro Electro-Mechanical Systems) microphones can be integrated on a semiconductor material by the IC (Integrated Circuit) technology to fabricate a miniaturized microphone. Now, MEMS microphones have become the mainstream of miniaturized microphones. MEMS microphones have advantages of compactness, lightweightness and low power consumption. Further, MEMS microphones can be fabricated with a surface-mount method, can bear a higher reflow temperature, can be easily integrated with a CMOS process and other audio electronic devices, and are more likely to resist radio frequency (RF) and electromagnetic interference (EMI).

Refer to FIG. 1 for a diagram schematically showing the structure of a conventional MEMS microphone. The conventional MEMS microphone 1 comprises a back plate 2, a flexible diaphragm 3 and a spacer 4. The spacer 4 is interposed between the back plate 2 and the flexible diaphragm 3, whereby the spacer 4 supports the rim of the flexible diaphragm 3 and insulates the flexible diaphragm 3 from the back plate 2. Thus, the back plate 2 and the flexible diaphragm 3 are parallel to each other and respectively form a lower electrode and an upper electrode of a parallel capacitor plate. The back plate 2 has a plurality of air holes 5 which are corresponding to the flexible diaphragm 3 penetrating the back plate 2 and intercommunicating with a back chamber 7 formed on a silicon substrate 6.

Applying voltage to the back plate 2 and flexible diaphragm 3 makes them respectively carry opposite charges and form a capacitor structure. A capacitance equation correlates to a parallel electrode plate is C=εA/d, wherein ε is the dielectric constant, A is the overlapped area of the two electrode plates, and d is the gap between the two capacitor plates. According to the equation, variation of the gap between the two capacitor plates will change the capacitance. When an acoustic wave causes the flexible diaphragm 3 to vibrate and deform, the gap between the back plate 2 and the flexible diaphragm 3 varies. Thus, the capacitance also varies to be converted into electric signals and output. The disturbed or compressed air between the flexible diaphragm 3 and the back plate 2 is released to the back chamber 7 via the air holes 5 lest drastic pressure damage the flexible diaphragm 3 and the back plate 2.

Refer to FIG. 2 for a diagram schematically showing the package structure of a conventional MEMS microphone. The conventional MEMS microphone 1 is installed on a baseplate 8 and packaged inside a holding space formed by a metallic cover 9. The flexible diaphragm 3 and the back plate 2 are respectively electrically connected with a conversion chip 10. The conversion chip 10 converts the variation of the capacitance between the back plate 2 and the flexible diaphragm 3 into electric signals to be output.

In the conventional MEMS microphones, sound pressure induces the deformation of the flexible diaphragm and changes the gap between the flexible diaphragm and the back plate, whereby the capacitance is varied. However, the flexible diaphragm is fabricated with a film-deposition method at a very high temperature. As different materials respectively have different thermal expansion coefficients, the diaphragm would accumulate tensile or compressive stress with different levels. Residual stress on the diaphragm will cause the warping or buckles of the diaphragm and lower the precision of detection. Moreover, due to the sensitivity of a microphone is inversely proportional to the residual stress of the diaphragm, higher residual stress results in low sensitivity.

An U.S. Pat. No. 5,490,220 entitled “Solid State Condenser and Microphone Devices” proposes a suspended diaphragm without the constant boundary, wherein a cantilever is used to support the diaphragm, such that the diaphragm is suspended to release stress caused by temperature effect. Another U.S. Pat. No. 5,870,482 entitled “Miniature Silicon Condenser Microphone” designs a large plate diaphragm with only one side fastened. An U.S. Pat. No. 7,023,066 entitled “Silicon Microphone” proposes a special structure design of the rim of the diaphragm to solve the problem of residual stress, such as provides tangential supporting springs along the rim of the diaphragm. No matter whether the cantilever or the tangential supporting spring is used to overcome the problem of residual stress, the design and fabrication process thereof are complicated and hard to completely overcome the problem of residual stress.

### SUMMARY OF THE INVENTION

One objective of the present invention is to provide an MEMS (Micro Electro-Mechanical Systems) capacitive microphone, whose diaphragm is easy to fabricate, favorable to release stress, and has high flatness, whereby is solved the conventional problem of thermal residual stress.

To achieve the abovementioned objective, the present invention proposes an MEMS capacitive microphone, which uses a supporting portion to support the center of a diaphragm to provide sufficient space to release stress, and which comprises a base, a back plate, an anchor member and a diaphragm. The back plate is arranged on the base and has a plurality of air holes. The base has a back chamber interconnecting with the air holes. The anchor member is arranged on the base and includes a supporting portion. The supporting portion supports the center of the diaphragm to make the diaphragm parallel to the back plate. Thereby, stress on the diaphragm is released outwards from the supporting portion.

The MEMS capacitive microphone of the present invention is characterized in that the diaphragm is supported in the center thereof. Thus, stress of the diaphragm is released outwards from the center thereof. Thereby is overcome the problem of deformation, buckles or fractures of the diaphragm caused by stress. Below, the embodiments are described in detail to demonstrate the present invention.

### BRIEF DESCRIPTION OF THE DRAWINGS

The embodiments are described in cooperation with the following drawings.

FIG. 1 is a diagram schematically showing the structure of a conventional MEMS microphone;

FIG. 2 is a diagram schematically showing the package structure of a conventional MEMS microphone;

FIG. 3A is a perspective view of an MEMS capacitive microphone according to one embodiment of the present invention;

FIG. 3B is a perspective sectional view of an MEMS capacitive microphone according to one embodiment of the present invention;

FIG. 4 is a diagram schematically showing the operation of an MEMS capacitive microphone according to one embodiment of the present invention;

FIG. 5A is a perspective view of an MEMS capacitive microphone according to another embodiment of the present invention;

FIG. 5B is a perspective sectional view of an MEMS capacitive microphone according to another embodiment of the present invention;

FIG. 6 is a diagram schematically showing the operation of an MEMS capacitive microphone according to another embodiment of the present invention;

FIGS. 7A-7I are sectional views schematically showing the process of fabricating an MEMS capacitive microphone according to another embodiment of the present invention; and

FIG. 8 is a diagram showing the result of a test under different frequencies of an MEMS capacitive microphone according to one embodiment of the present invention.

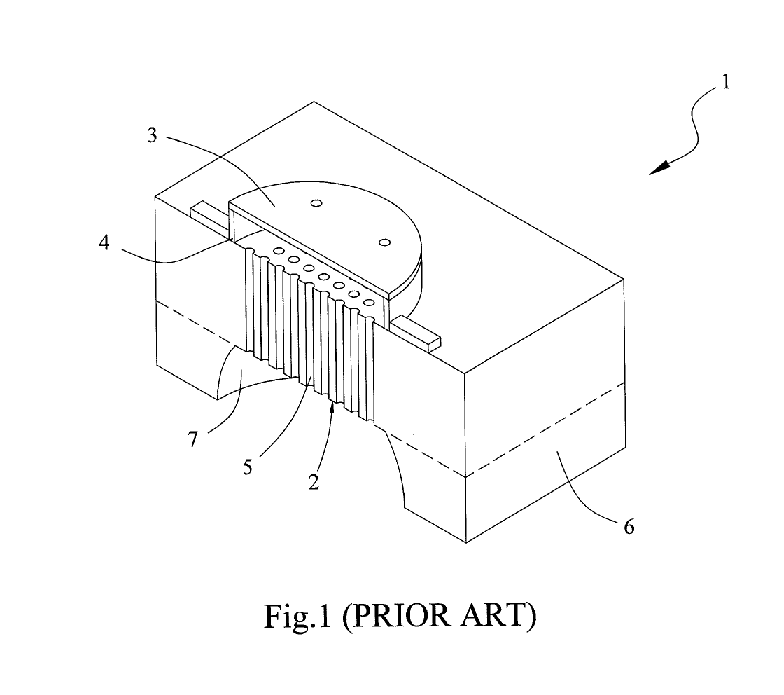

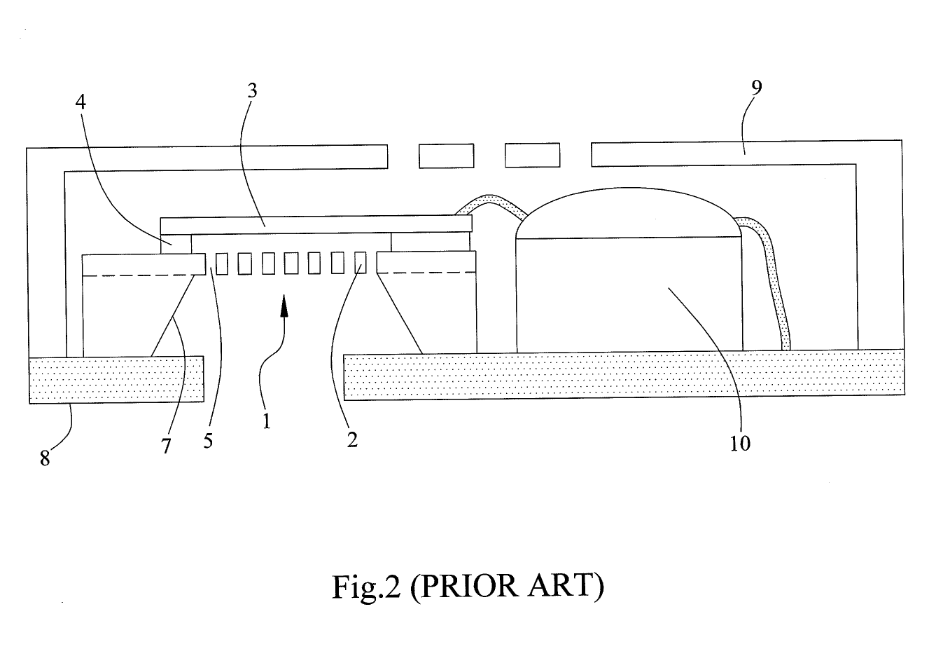

### DETAILED DESCRIPTION OF THE PREFERRED EMBODIMENTS

The present invention proposes an MEMS capacitive microphone, which uses a supporting portion to support the center of a diaphragm to favorably release residual stress. The technical contents of the present invention are described in detail in cooperation with the drawings below.

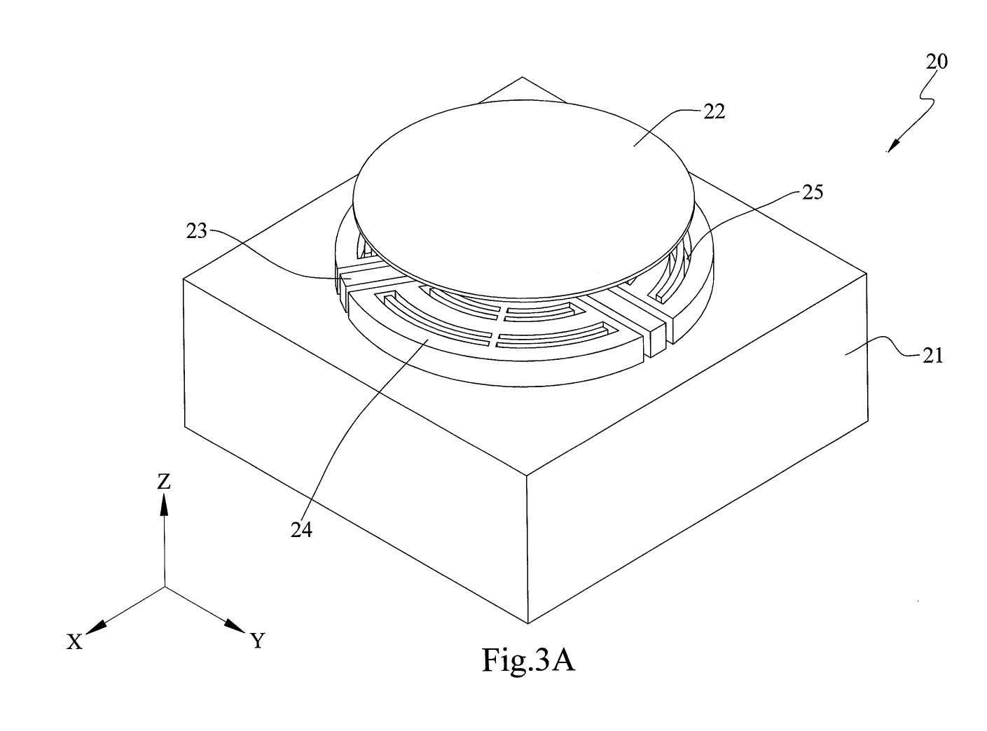

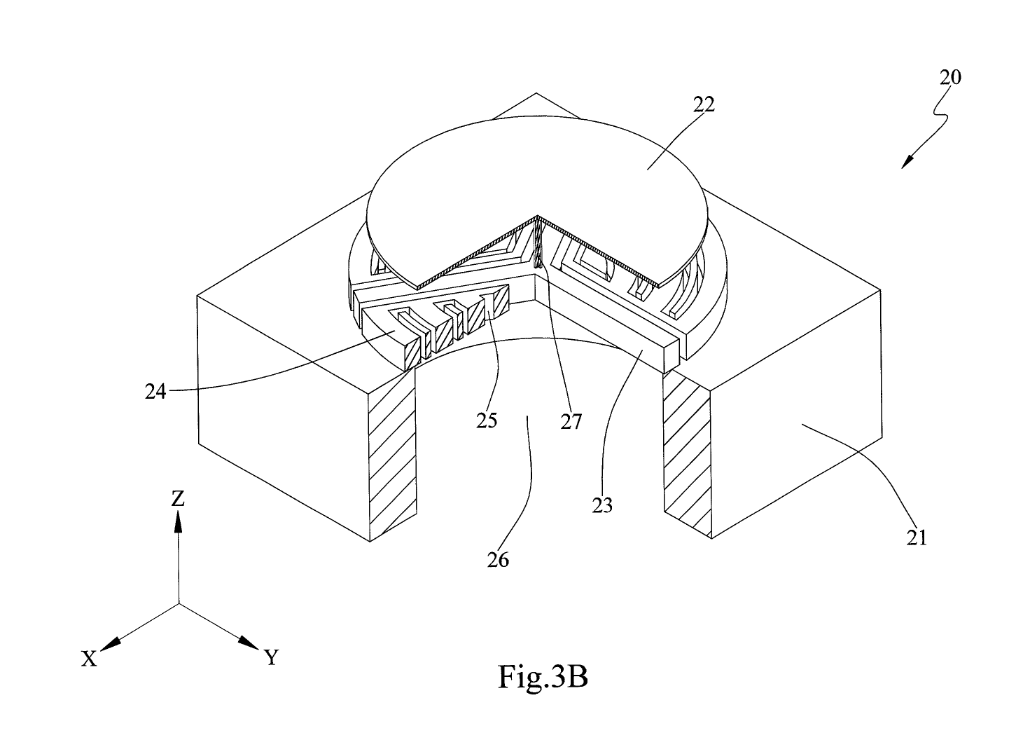

Refer to FIG. 3A and FIG. 3B. In one embodiment of the present invention, the MEMS capacitive microphone 20 comprises a base 21, a diaphragm 22, an anchor member 23 and a back plate 24. The back plate 24 is arranged on the base 21 and has a plurality of air holes 25 penetrating the back plate 24. The base 21 has a back chamber 26 corresponding to the back plate 24, such that the air holes 25 interconnect with the back chamber 26. The anchor member 23 is arranged on the base 21 and straddles the back chamber 26. The anchor member 23 further comprises a supporting portion 27. The supporting portion 27 supports the center of the diaphragm 22 to make the diaphragm 22 parallel to the back plate 24.

It should be particularly mentioned that residual stress on the diaphragm 22 is normally released radially from the center toward the rim. Therefore, supporting the diaphragm 22 in the central portion thereof favors releasing residual stress of the diaphragm 22. Considering stability of the diaphragm 22, the abovementioned central portion can be the geometric center (gravitational center) of the diaphragm 22 or on the symmetric axis of the diaphragm 22. In one embodiment, the supporting portion 27 supports the center of a circular diaphragm 22. For convenience of description, the present invention will use this embodiment as the exemplification thereinafter. However, the present invention is not limited by this embodiment. Besides, the supporting portion 27 can a post fixedly installed on the anchor member 23 in one embodiment.

In one embodiment, the diaphragm 22 is a flexible diaphragm. The geometric center of the diaphragm 22 is supported by the supporting portion 27 to form a static end. The rim of the diaphragm 22 thus forms a free end vibrated or deformed by sound waves. Such a design makes residual stress of the diaphragm 22 released from the static end toward the free end and prevents the diaphragm 22 from buckling or deforming.

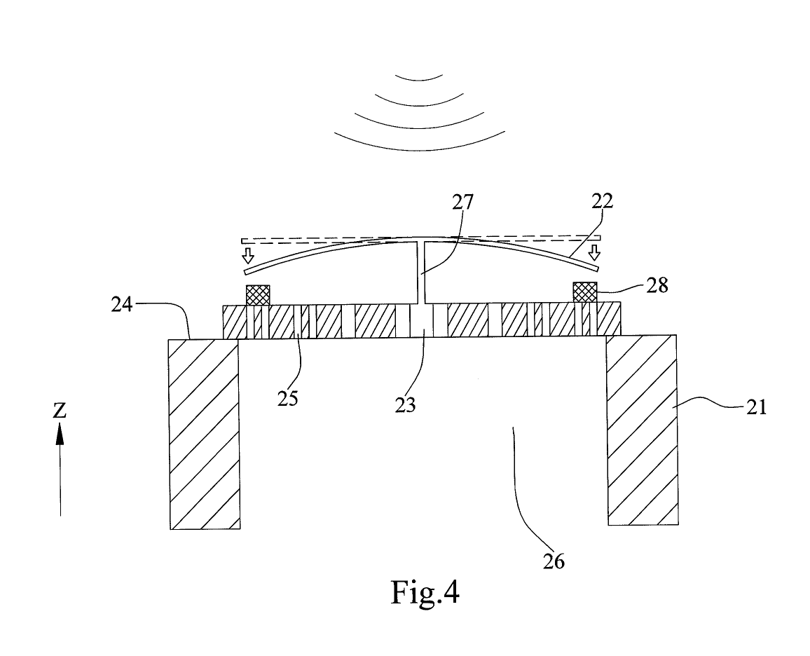

In one embodiment, the base 21 is a silicon substrate having a circular back chamber 26 formed therein. The anchor member 23 is formed in a cross shape. The terminals of the cross-shape anchor member 23 are fixed to the rim of the back chamber 26. The back plate 24 is fixedly arranged on one side of the back chamber 26 of the base 21, has a plurality of air holes 25, and has a holding space reserved for the anchor member 23. The diaphragm 22 is arranged above the back plate 24 and parallel to the back plate 24, whereby is formed a parallel capacitor plate. Refer to FIG. 4. When positive and negative voltages are respectively applied to the diaphragm 22 and the back plate 24, the diaphragm 22 and the back plate 24 are oppositely charged to form a parallel capacitor plate capacitor. When sound waves act on the diaphragm 22, the free end of the diaphragm 22 vibrates and deforms. Thus is changed the capacitance between the diaphragm 22 and the back plate 24. Via computation and analysis of an external circuit, the acoustic signals are converted into electric signals to be output. Meanwhile, the air, which is disturbed by the vibration of the diaphragm 22, is discharged from the air holes 25 of the back plate 24 to the back chamber 26.

Refer to FIG. 4 again. In one embodiment, the MEMS capacitive microphone 20 further comprises at least one insulation element 28 arranged between the diaphragm 22 and the back plate 24. The insulation elements 28 may be arranged on one side of the diaphragm 22 facing the back plate 24 or arranged on one side of the back plate 24 facing the diaphragm 22. In FIG. 4, two insulation elements 28 are respectively arranged on two sides of the back plate 24. When too much acoustic pressure causes too great deformation of the diaphragm 22, the insulation elements 28 can provide cushion effect and function as electric separation of the diaphragm 22 from the back plate 24 lest the electric contact of the diaphragm 22 and the back plate 24 damage the microphone.

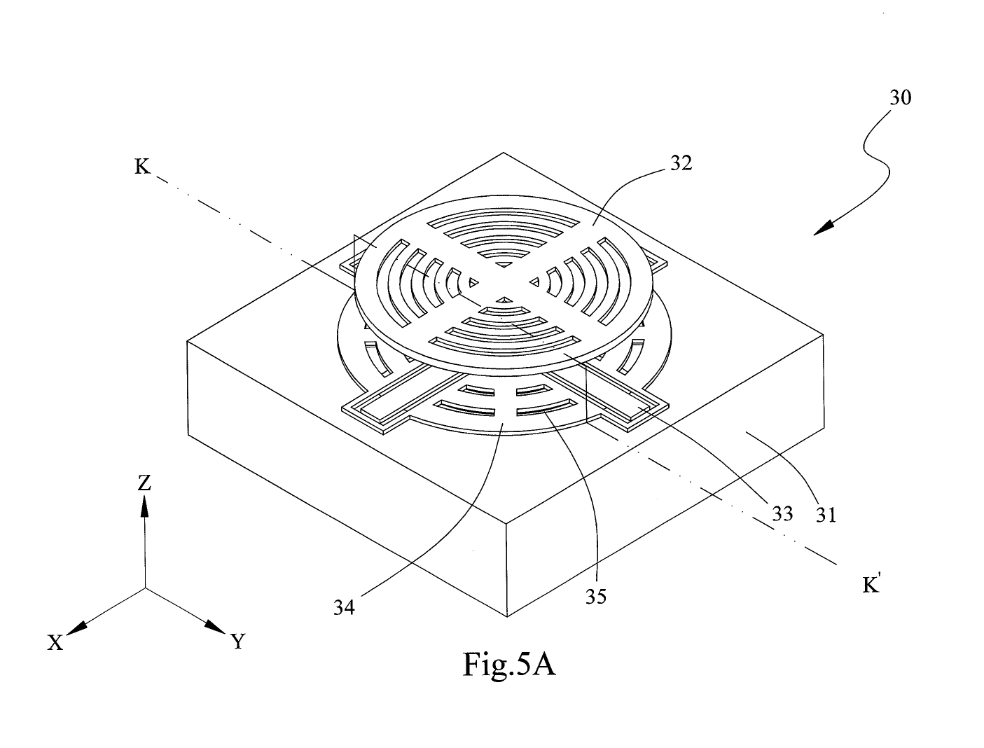

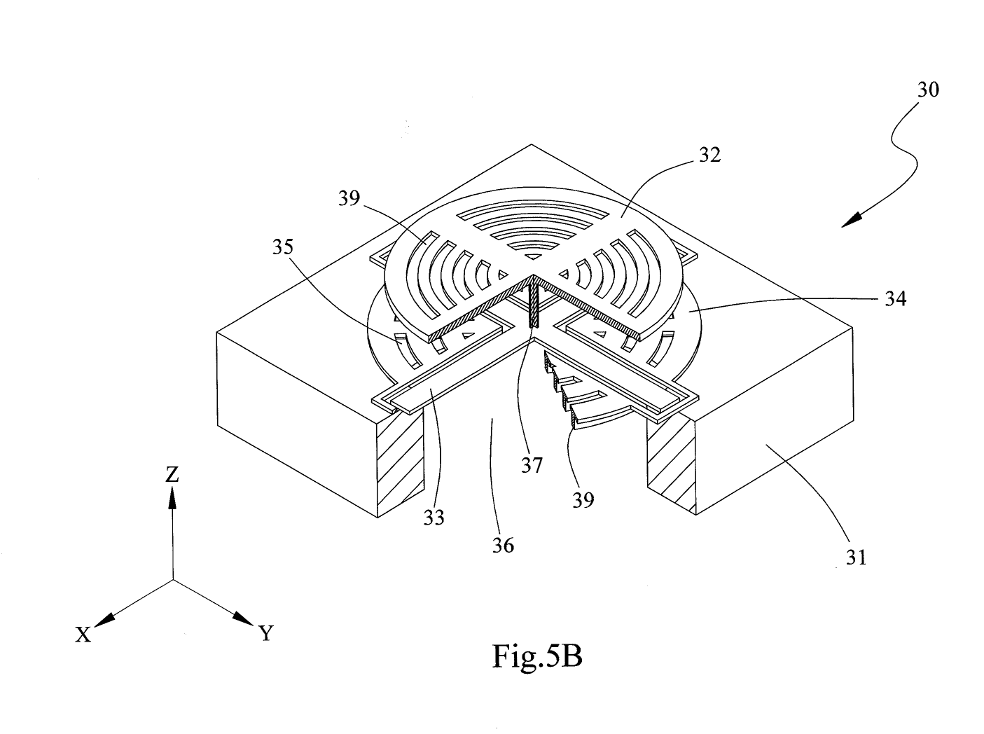

The design that the supporting portion 27 supports the geometric center of the diaphragm 22 also can be applied to a rigid diaphragm. Refer to FIG. 5A and FIG. 5B for respectively a perspective view and a sectional view schematically showing an MEMS capacitive microphone according to a second embodiment of the present invention. The MEMS capacitive microphone 30 of the present invention comprises a base 31, a rigid diaphragm 32, an elastic element 33 and a back plate 34. The back plate 34 is arranged on the base 31. The back plate 34 has a plurality of air holes 35 penetrating the back plate 34. The base 31 has a back chamber 36 corresponding to the back plate 34, and the air holes 35 interconnect with the back chamber 36. The rigid diaphragm 32 is fixed on the elastic element 33 and parallel to the back plate 34. The back plate 34 forms a static end relative to the rigid diaphragm 32. The rigid diaphragm 32 may be moved by the elasticity of the elastic element 33 and forms a movable end relative to the back plate 34. Thus, when a sound wave acts on the rigid diaphragm 32, the rigid diaphragm 32 is moved relative to the back plate 34, but always parallel to a normal of the back plate 34, i.e. the z axis. According to the abovementioned equation of a parallel capacitor plate, the capacitance variation between the rigid diaphragm 32 and the back plate 34 can be rewritten to ΔC=εA/(d−Δx), wherein d is the original gap between the back plate 34 and the rigid diaphragm 32 before acted by acoustic pressure, and Δx is the displacement of the rigid diaphragm 32 acted by acoustic pressure. Comparing with a conventional flexible diaphragm that the gap between the back plate 34 and each point of the flexible diaphragm has different displacement, the capacitance variation only correlates with Δx in the present invention. Therefore, the present invention can provide a greater capacitance variation output and enhance the sensitivity of a microphone.

Refer to FIG. 5B. In one embodiment, the base 31 may be a silicon substrate with a circular back chamber 36 formed thereon. The elastic element 33 is formed in a cross shape, and the four ends thereof are fixed to the rim of the back chamber 36 of the base 31. The rigid diaphragm 32 is formed in a circular shape and fixedly anchored to the intersection of the cross-shape elastic element 33 by a supporting element 37. Thus, the rigid diaphragm 32 is parallel to the plane of the elastic element 33. The supporting element 37 has one end relative to the elastic element 33 is fixed to the center of the circular rigid diaphragm 32. The supporting element 37 can maintain physical balance of the rigid diaphragm 32 and facilitate release of the thermal stress generated in a thermal fabrication process.

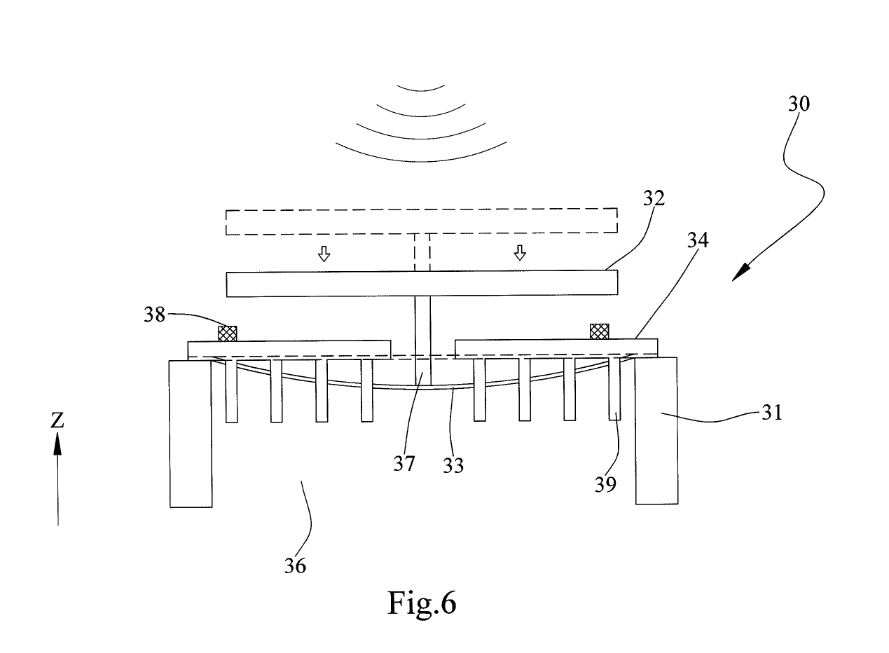

The back plate 34 is fixedly installed on one side of the back chamber 36 of the base 31 and has a plurality of air holes 35 formed thereon, but a holding space of the back plate 34 is reserved for receiving the elastic element 33. The rigid diaphragm 32 is arranged above the back plate 34 and parallel to the back plate 34, whereby is formed a parallel capacitor plate. Refer to FIG. 6. In operation, the positive and negative voltages are respectively applied to the rigid diagram 32 and the back plate 34, whereby the rigid diagram 32 and the back plate 34 respectively carry positive charges and negative charges and form a parallel-plate capacitance. When a sound wave acts on one surface of the rigid diaphragm 32, the acoustic pressure is transmitted to the elastic element 33 to be deformed. Thus, the rigid diaphragm 32 is moved toward the back plate 34 along the Z axis, and the capacitance between the rigid diaphragm 32 and the back plate 34 is changed. By means of analysis and computation of the capacitance variation by an external circuit, sound signals are converted into electric signals to be output.

Refer to FIG. 6 again. In one embodiment, the MEMS capacitive microphone 30 of the present invention further comprises at least one insulation element 38 arranged between the rigid diaphragm 32 and the back plate 34. The insulation element 38 may be arranged on one surface of the rigid diaphragm 32 facing the back plate 34 or arranged on one surface of the back plate 34 facing the rigid diaphragm 32. In FIG. 6, two insulation elements 38 are respectively arranged on two ends of the back plate 34. When too much acoustic pressure causes too great displacement of the rigid diaphragm 32 toward the back plate 34, the insulation elements 38 can provide cushion effect and function as electric separation of the rigid diaphragm 32 from the back plate 34 lest electric contact of the rigid diaphragm 32 and the back plate 34 damage the microphone.

In one embodiment, the rigid diaphragm 32 includes a plurality of reinforcing members (not shown in the drawings), such as reinforcing ribs arranged on one side of the rigid diaphragm 32 to enhance the structural strength of the rigid diaphragm 32 and maintain the rigidity of the rigid diaphragm 32.

In one embodiment, the back plate 34 includes a plurality of reinforcing members 39, such as reinforcing ribs arranged on one side of the back plate 34 back on the rigid diaphragm 32 to enhance the structural strength of the back plate 34 and maintain the rigidity of the back plate 34.

For convenient illustration, the parts having different functions are separately defined hereinbefore. However, it should be noted that the abovementioned parts can be fabricated independently and then assembled together, or fabricated directly with an MEMS or semiconductor process, such as the etching, photolithographing, and refilling technologies. For example, an MEMS capacitive microphone can be fabricated with a MOSBE platform, which was disclosed in “The Molded Surface-micromachining and Bulk Etching Release (MOSBE) Fabrication Platform on (111) Si for MOEMS” (Journal of Micromechanics and Microengineering, vol. 15, pp. 260-265) in 2005. Thus, it is not repeated herein.

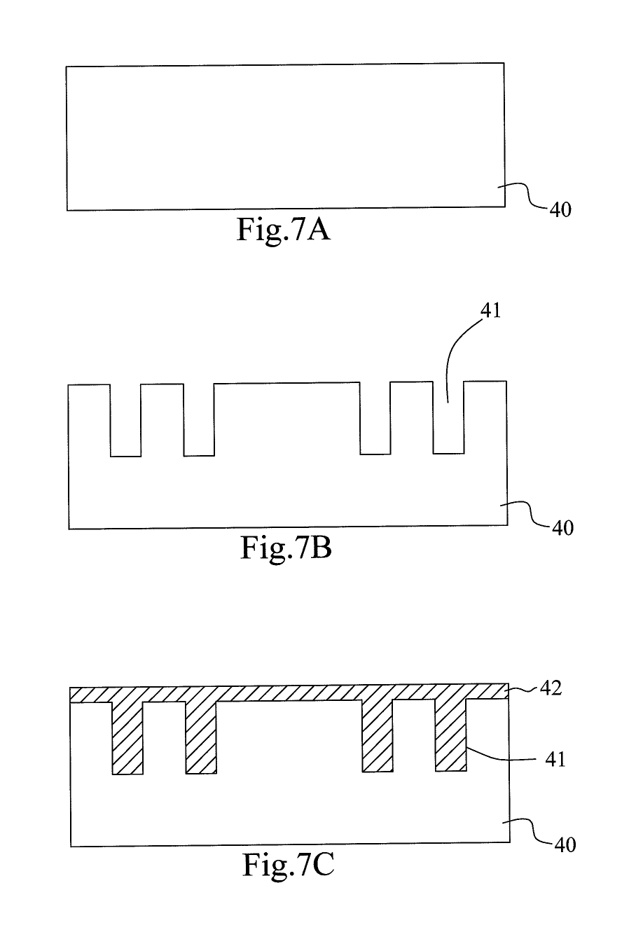

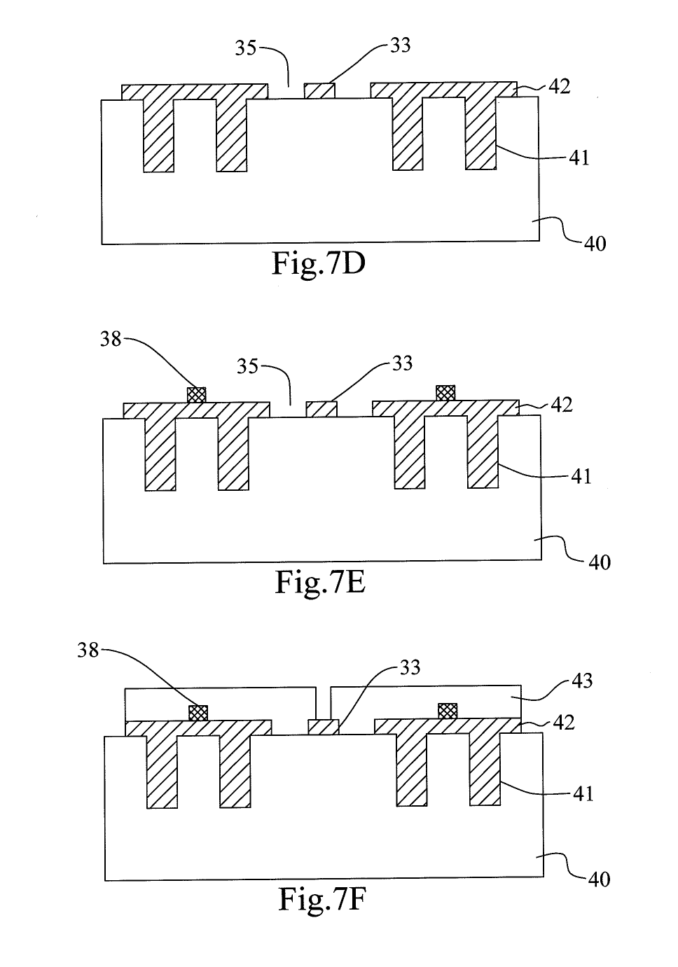

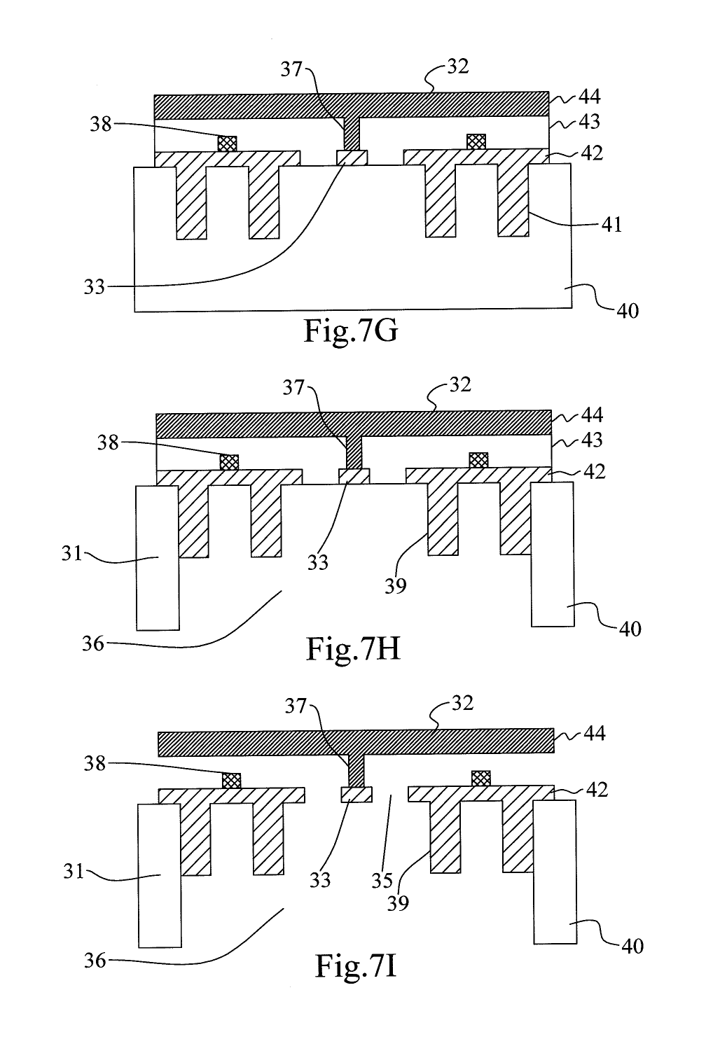

Refer to FIGS. 7A-7I for sectional views schematically showing the process of fabricating the MEMS capacitive microphone 30 according to one embodiment of the present invention, wherein the sectional views are taken along Line K-K′ in FIG. 5A, and electric wiring processes of different elements are omitted if the omission does not affect the implementation and understanding of the present invention. Firstly, prepare a substrate for fabricating the base 31, such as a silicon substrate 40, as shown in FIG. 7A. Next, define the installation position of the back plate 34 on the silicon substrate 40, and fabricate trenches 41 for forming the reinforcing members 39 on the silicon substrate 40 via an etching method, as shown in FIG. 7B. Next, deposit a poly-silicon layer 42 on the silicon substrate 40 to refill the trenches 41 and form the reinforcing members 39 of the back plate 34, as shown in FIG. 7C. Next, define the positions of the elastic element 33 and the air holes and define the area of the back plate 34 via etching the poly-silicon layer 42, as shown in FIG. 7D. The reinforcing members 39 can maintain the flatness and rigidity of the back plate 34. The elasticity of the elastic element 33 can be adjusted via varying the thickness of the poly-silicon layer or selecting the material thereof.

Next, form the insulation elements 38 on the back plate 34, as shown in FIG. 7E. In one embodiment, the insulation elements 38 are made of silicon nitride (Si₃N₄). Next, form an intermediary layer 43 above the back plate 34, and define the position for forming the supporting element 37 on the intermediary layer 43, wherein the position for forming the supporting element 37 is above the elastic element 33, as shown in FIG. 7F. In one embodiment, the intermediary layer 43 is made of silicon dioxide (SiO₂). Next, deposit a poly-silicon layer 44 on the intermediary layer 43 for forming the rigid diaphragm 32 and the supporting element 37, as shown in FIG. 7G. Next, etch the bottom of the silicon substrate 40 to form the back chamber 36, as shown in FIG. 7H. Then, remove the intermediary layer 43 via etching such that the rigid diaphragm 32 is supported by the supporting element 37 on the elastic element 33 and parallel to the back plate 34, as shown in FIG. 7I.

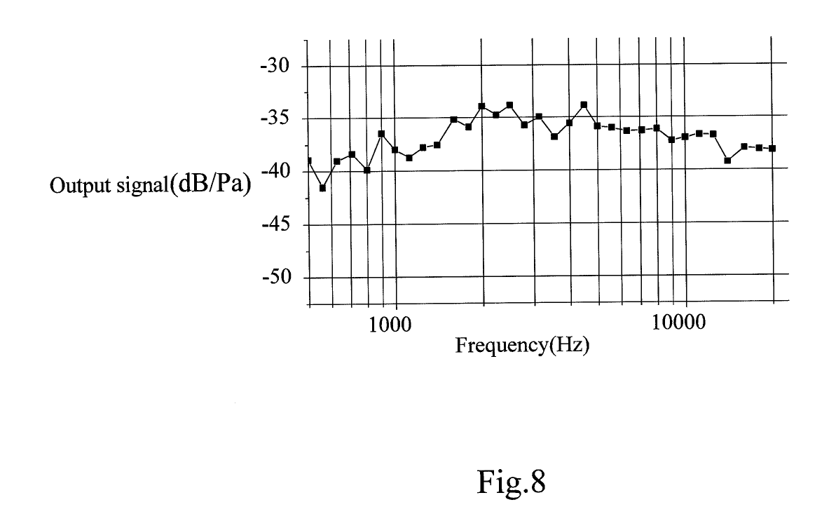

Refer to FIG. 8 for a diagram showing the result of a test under different frequencies of an MEMS capacitive microphone according to one embodiment of the present invention, wherein the MEMS capacitive microphone 30 is electrically connected with a capacitance readout IC (MS3110) and placed in a semi-anechoic chamber to receive signals from a loudspeaker. When the sound level is below 94 dB, the MEMS capacitive microphone 30 can sense a frequency of a sound of 10-20000 Hz. The MEMS capacitive microphone 30 has a sensitivity of about 12.63 mV/Pa or −37.97 dB/Pa. The MEMS capacitive microphone 30 has advantages of high sensitivity, compactness and low cost. Further, the rigid diaphragm 32 of the MEMS capacitive microphone 30 is less likely to have residual stress and thus has higher sensitivity in comparison with the conventional flexible diaphragm.

It should be explained that “rigid” of the rigid diaphragm 32 is not purely defined by the hardness thereof but related to capacitive sensing principle thereof. As described above, the rigid diaphragm 32 means that the diaphragm is incorporated with the elastic element 33 to change the capacitance between the rigid diaphragm 32 and the back plate 34 due to the elasticity or deformation of the elastic element 33 but not the deformation of the diaphragm itself. Further, the realizations of the elastic element 33 are not limited to those in abovementioned embodiments.

In the MEMS capacitive microphone of the present invention, the diaphragm is supported in the geometric center thereof to make the residual stress of the diaphragm released outward from the center. Thereby is overcome the problem of deformation or fracture of the diaphragm caused by the residual stress generated by high temperature processes.

The embodiments described above are only to exemplify the present invention but not to limit the scope of the present invention. Any equivalent modification or variation according to the technical contents of the specification or drawings is to be also included within the scope of the present invention.

What is claimed is:

1. A micro electro-mechanical system capacitive microphone, comprising:
a base including a back chamber formed thereon;
a back plate arranged on the base and including a plurality of air holes interconnecting with the back chamber;
an anchor member arranged on the base and further including a supporting portion; and
a diaphragm including a central portion supported by the supporting portion to make the diaphragm parallel to the back plate, whereby stress of the diaphragm is released outward from the supporting portion.

2. The micro electro-mechanical system capacitive microphone according to claim 1, wherein the supporting portion supports a geometric center of the diaphragm.

3. The micro electro-mechanical system capacitive microphone according to claim 2, wherein the diaphragm is a circular diaphragm and includes a center supported by the supporting portion.

4. The micro electro-mechanical system capacitive microphone according to claim 1, wherein the supporting portion supports a symmetric axis of the diaphragm.

5. The micro electro-mechanical system capacitive microphone according to claim 1, wherein the diaphragm is a flexible diaphragm.

6. The micro electro-mechanical system capacitive microphone according to claim 1, wherein the diaphragm is a rigid diaphragm.

7. The micro electro-mechanical system capacitive microphone according to claim 1, wherein the back plate includes a plurality of reinforcing members arranged on one side of the back plate.

8. The micro electro-mechanical system capacitive microphone according to claim 1, wherein the base is made of silicon.

9. The micro electro-mechanical system capacitive microphone according to claim 1, wherein the diaphragm is made of silicon of polycrystalline.

10. The micro electro-mechanical system capacitive microphone according to claim 1 further comprising at least one insulation element arranged between the diaphragm and the back plate to prevent the diaphragm from electrically contacting the back plate.

11. The micro electro-mechanical system capacitive microphone according to claim 10, wherein the insulation element is made of silicon nitride.

12. A micro electro-mechanical system capacitive microphone comprising a back plate, an anchor member and a diaphragm, wherein the anchor member further comprising a supporting portion, and the supporting portion supports a geometric center of the diaphragm to make the diaphragm parallel to the back plate, whereby stress of the diaphragm is released outward from the geometric center.

13. A micro electro-mechanical system capacitive microphone comprising a diaphragm, wherein the diaphragm is supported by a supporting element in a center thereof to form a static end, and a rim of the diaphragm forms a free end, whereby stress of the diaphragm is released from the static end toward the free end.
